(19) United States
(12) Patent Application Publication
(10) Pub. No.: US 2006/0265938 A1
(43) Pub. Date: Nov. 30, 2006

(54) Fish hooks

(76) Inventor: Michael H. Heggeness, Bellaire, TX (US)

Correspondence Address: LAURA G. BARROW, P.O. BOX 215, ESTERO, FL, 33928, US

(21) Appl. No.: 11/441,560

(22) Filed: May 26, 2006

Related U.S. Application Data
(60) Provisional application No. 60/685,647, filed on May 27, 2005.

(51) Int. Cl. A01K 83/06; A01K 83/00; A01K 85/08

(52) U.S. Cl. 43/44.8; 43/43.16; 43/42.25; 43/44.2

(57) ABSTRACT

The present invention is directed to novel fish hooks for use in making fishing flies or lures. The inventive hooks are designed such that the fishing fly dressings (e.g. fur, feathers, artificial eyes, artificial wings, tinsel, and other material) used to make the fly or lure may be securely affixed thereto. The design of the inventive hook, as described in more detail below, prevents the fishing fly dressings from loosening, thereby increasing the effectiveness of the fish hook in attracting and ensnaring fish.

### This application claims the benefit of the filing of co-pending U.S. provisional application Ser. No. 60/685,647, filed May 27, 2005, which is incorporated by reference herein in its entirety.

### BACKGROUND OF THE INVENTION

The use of fishing flies and lures is common. While many individuals make or “tie” their own flies, others purchase fishing flies. In either case, in order to induce the fish to bite the hook, and thereby be caught on the catch end of the hook, a variety of “dressings,” such as feathers, fur, tinsel, artificial eyes and wings, and other materials, are secured to the hook, either tied to the hook or to glued thereon, for example. Whether the fishing fly is hand-made or store-bought, a common problem with a fly in use is that the fly can become damaged by contact with the water, sand, soil, weeds, and even the fish themselves. In addition, because many fish hooks in the art are polished to a very smooth finish (see FIG. 1), it is difficult to effect a secure attachment of the thread of the dressing to the slippery outer surface of the hook shank, even if attempts are made to glue the dressing to the hook. As a result, loosening of the fur and feather construct on the elongated shaft section of the hook often occurs, which allows the fly materials to rotate or slip along the shaft of the hook. Not only does this slippage lead to damage of the fishing fly in the that the dressing ultimately falls off the fly, but the rotation and slipping of the dressing about the shank is less likely to fool the fish into biting. This loosening of the dressing materials, particularly the rotation of the dressing materials about the hook, is a very common, if not the most common, way that a fishing fly in use is “ruined,” and thus must be replaced.

### SUMMARY OF THE INVENTION

The present invention is directed to a novel fish hook suitable for use in making fishing flies and lures. In certain aspects of the invention, the fish hook comprises an elongated shank section and a U-shaped hook section. The shank section has a looped end for attachment to a fishing line and an opposite end terminating into the U-shaped hook section, the shank section further having a non-smooth, textured outer surface for securing fishing fly dressings thereto. The U-shaped hook section includes a catch end, the catch end having a tip and a barb. The fish hook may further include one or more fishing fly dressings secured to the non-smooth, textured outer surface of the shank section. The fishing fly dressings may be selected from the group of feathers, fur, tinsel, artificial eyes, and artificial wings.

In some embodiments of the invention, the shank section comprises an outer circumference, wherein the non-smooth, textured outer surface is provided upon the entire outer circumference of the shank section. Alternatively, the non-smooth, textured outer surface is provided upon a portion of the outer circumference of the shank section.

The fish hook may be formed of a metal or metal alloy, with the non-smooth, textured outer surface of the shank portion having a texture selected from the group of a scored texture, a knurled texture, roughened texture resulting from sandblasting, roughened texture resulting from controlled corrosion, roughened texture resulting from controlled gouging or roughing via a machine, stamping or casting. The non-smooth, textured outer surface of the shank portion may also comprise a textured material applied to the outer surface of the shank portion, the textured material selected from the group of paint, glaze, adhesives, rubber, and plastic.

In other aspects of the present invention, the fish hook comprises an elongated shank section and a U-shaped hook section, with the shank section having a looped end for attachment to a fishing line and an opposite end terminating into the U-shaped hook section. The U-shaped hook section further includes a catch end, the catch end having a tip and a barb. The fish hook further includes a transverse bar secured to the shank section and oriented subjacent to the looped end, the bar configured for attaching fishing fly hook dressing thereto. The fish hook may further include one or more fishing fly dressings secured to the transverse bar, the fly dressings being selected from the group of feathers, fur, tinsel, artificial eyes, and artificial wings. In addition to the transverse bar, the shank section of the fish hook may further include a non-smooth, textured outer surface for securing fishing fly dressings thereto, the fly dressings also being selected from the group of feathers, fur, tinsel, artificial eyes, and artificial wings. In this latter fish hook embodiment, the fish hook may be formed of a metal or metal alloy, with the non-smooth, textured outer surface of the shank portion having a texture selected from the group of a scored texture, a knurled texture, roughened texture resulting from sandblasting, roughened texture resulting from controlled corrosion, roughened texture resulting from controlled gouging or roughing via a machine, stamping or casting. The non-smooth, textured outer surface of the shank portion may also comprise a textured material applied to the outer surface of the shank portion, the textured material selected from the group of paint, glaze, adhesives, rubber, and plastic.

### BRIEF DESCRIPTION OF THE FIGURES

FIG. 1 illustrates a typical fish hook of the prior art having a non-textured, smooth polished shank section.

FIG. 2 is a side view of one embodiment of the fish hook of the present invention, wherein the texture is provided on most of the outer surface of the shank section along most of or the entire length of the shank section.

FIG. 3 is a side view of a second embodiment of the inventive hook, wherein the texture is provided on a portion of the outer surface of the hook's shank along a shorter length portion compared to that shown in FIG. 2.

FIG. 4 and FIG. 5 are side views of third embodiment of the inventive hook.

FIG. 6 is a side view of the hook shown in FIG. 5, showing attachment of beads or artificial eyes to a bar portion of the hook.

FIG. 7 is a cross section view taken along lines 7-7 of FIG. 2.

FIG. 8 is a cross section of the inventive hook similar to that illustrated in FIG. 7, with only a portion of the circumference of the shank section having a textured outer surface.

FIG. 9 is a side view of a fourth embodiment of the inventive hooks.

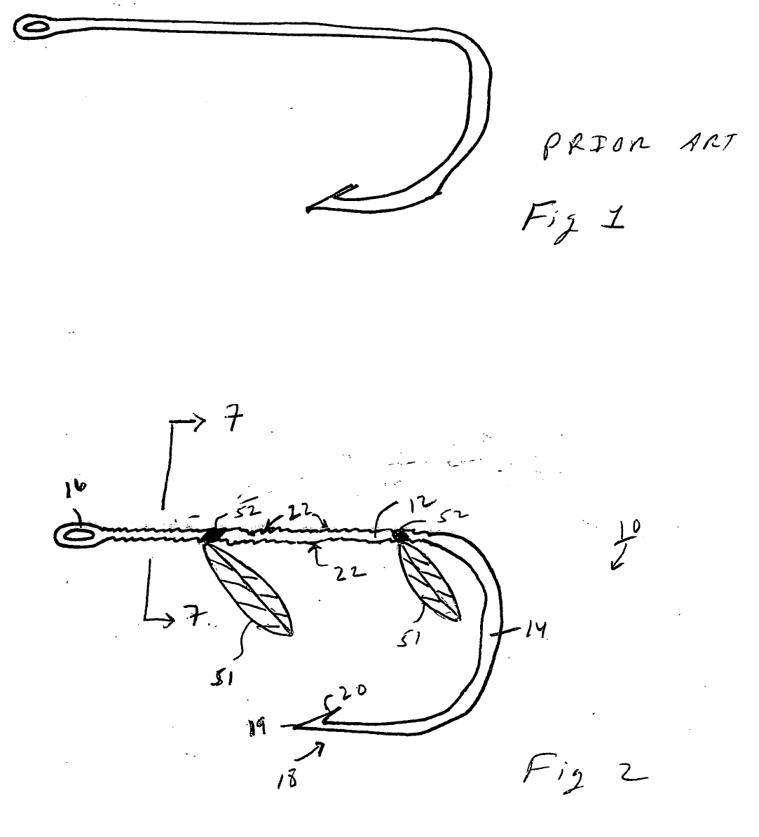

### DETAILED DESCRIPTION OF THE EMBODIMENTS OF THE INVENTION

The present invention is directed to novel fish hooks for use in making fishing flies or lures. The inventive hooks are designed such that the fish hook dressings (e.g. fur, feathers, artificial eyes, artificial wings, tinsel, and other material) used to make the fly or lure may be securely affixed thereto. The design of the inventive hook, as described in more detail below, prevents the fish hook dressings from loosening, thereby increasing the effectiveness of the fish hook in attracting and ensnaring fish.

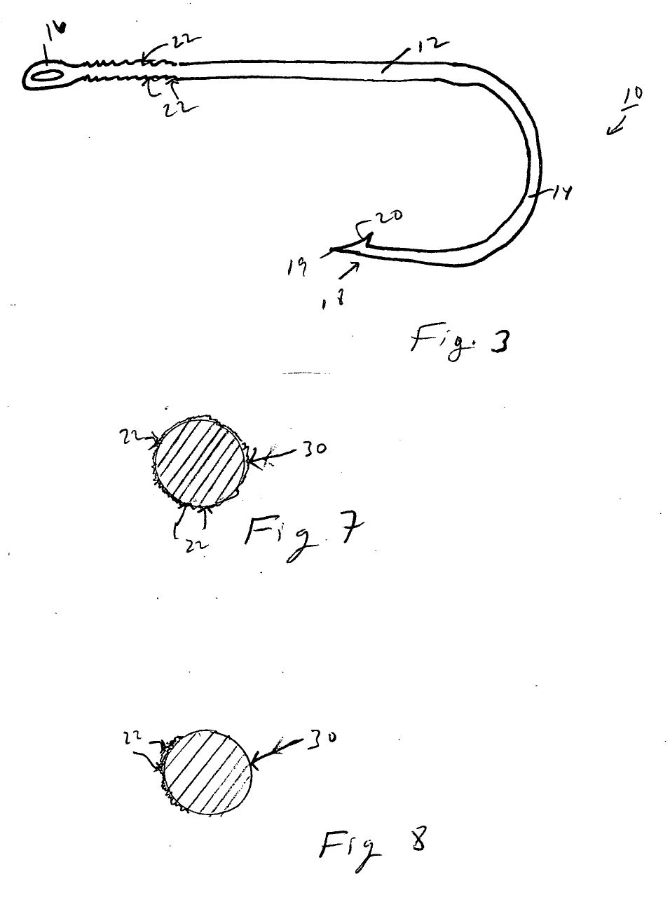

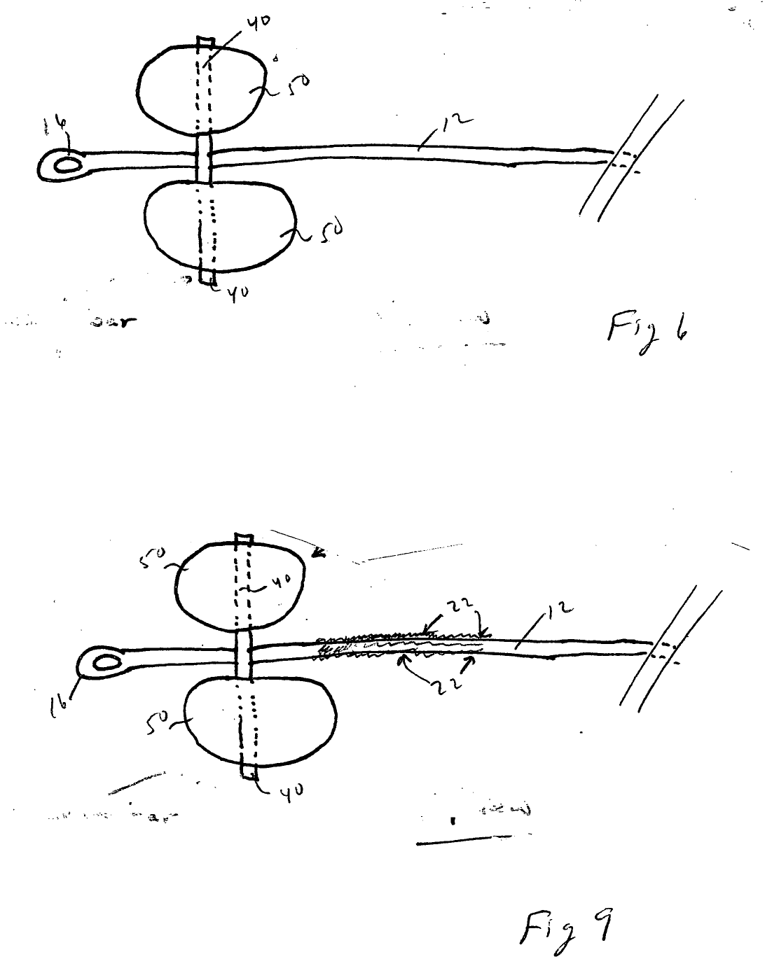

As shown in the figures, the fish hook 10 of the present invention comprises an elongated shank section 12. The shank section further includes a looped end 16 to which a fishing line (not shown) may be secured. The shank section 12 also has an opposite end terminating into a U-shaped hook section 14. This U-shaped hook section includes a catch end 18 for “hooking” the fish, the catch end comprising a tip 19 and a barb 20. In certain embodiments of the present invention, the elongated shank section has a non-smooth textured outer surface. Specifically, the outer surface is textured with bumps, grooves, ridges, knurling, and the like, generally referenced as 22. Exemplary means for providing this texture 22 to the hook shank section are listed below. Provision of this textured surface allows the wrapping thread 52 of the fishing fly dressing 51 (see FIG. 2) to resist slipping on the shaft of the hook. Specifically, the fly dressings are less likely to rotate about shaft or slide up or down along the shaft. Minimizing this movement of the dressing along the shank not only has the advantage of making the fishing fly more durable, but it also makes the fly look more “life like,” and thus more likely to fool the fish into biting. As shown in FIG. 2, the texture may be applied about most of or the entire length of the shank section, or as shown in FIG. 3, along a shorter portion of the length of the shank section 12. Also, the texture may be applied about the entire circumference 30 of the outer surface of shank section, or the texture may be applied to a portion of the circumference of the outer surface of the shank section (see FIG. 8). [For ease of illustration, the fly dressings are only shown in FIGS. 2 and 6-9.[

It will be readily recognized by those of ordinary skill in the art that the texture 22 may be provided to the outer surface of the shank by any number of means, including but not limited to, scoring with a file, anodizing, knurling, controlled corrosion, sandblasting and other abrasive treatments, stamping, casting, controlled gouging or roughing of the surface by a machine, and the application of paint, glaze, or adhesive. A sufficient non-smooth texture may also be accomplished by omitting the polishing step for all or a portion of the hook's shaft during the manufacture of the hook. Moreover, the application of a solder alone, or the soldering or welding of additional material to the hook that will create purchase of the thread and/or dressing materials may also be employed.

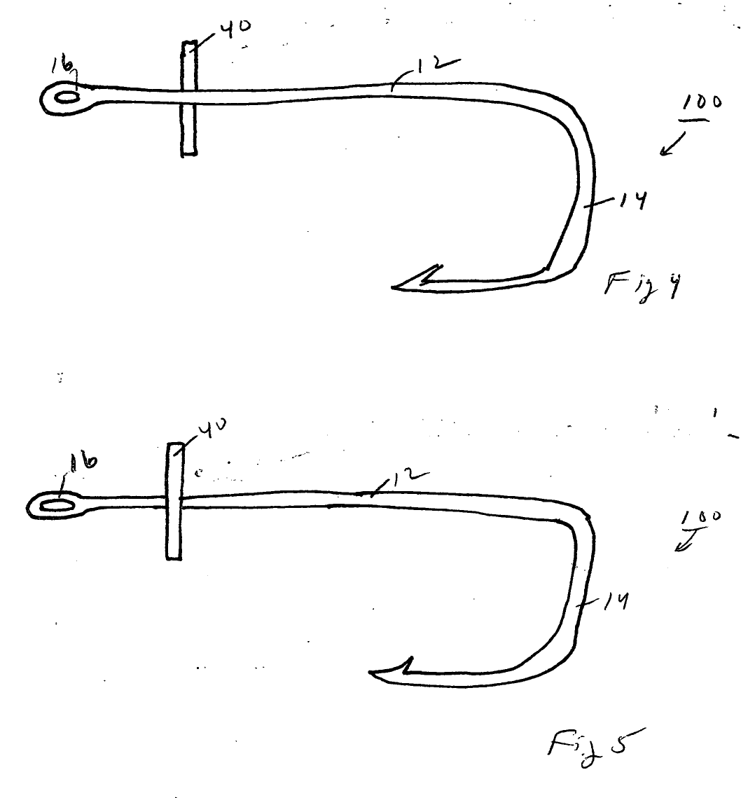

FIGS. 4 and 5 illustrate another embodiment of the inventive hook 100, whereby a small transverse bar 40 is secured to the shank section 12 as shown. This bar 40 may be provided on either side of the shank section, as shown. The bar 40 may be welded or glued to the hook by conventional means. This embodiment is useful for securing beads or artificial eyes 50 to the hook by an adhesive. Other fishing fly dressing materials such as artificial gills, fins, wings, or antennae of the fly could be secured to the wire. As used herein, the term “bar” shall include small rods, wires, bars, and the like suitable for engaging the fishing fly dressings described herein as well as those illustrated in the figures. The thread of dressing materials such as fur and feathers, for example, could also be wrapped securely around both the bar and shank section for secure attachment to the hook (not shown). As shown in FIG. 9, all or a portion of the outer surface (both circumference and length) of the shank section may also be provided in this embodiment as described above and illustrated herein for the embodiments that do not employ a transverse bar 40. This latter embodiment shown in FIG. 9 may be particularly useful for securing a greater variety of fly dressing materials to the hook, such as artificial eyes or wings, for example, to the bar 40, and the thread 52 of other dressing materials (e.g. fur or feathers 51) to the textured outer surface of the shank section.

The inventive hook may be formed of any conventional material known and currently used (or later developed) in the manufacturing of fish hooks. Metal and metal alloys are currently the most common metals, although as discussed above, the texture provided to the shank section of the hook may be of a different material, such as, for example, rubber, plastic, dry adhesives, and the like.

1. A fish hook suitable for use in making fishing flies and lures, said hook comprising:
an elongated shank section and a U-shaped hook section;
said shank section having a looped end for attachment to a fishing line and an opposite end terminating into said U-shaped hook section;
said U-shaped hook section having a catch end, said catch end having a tip and a barb; and
said shank section having a non-smooth, textured outer surface for securing one or more fishing fly dressings thereto.

2. The fish hook of claim 1, further including one or more fishing fly dressings secured to said non-smooth, textured outer surface of said shank section.

3. The fish hook of claim 1, said shank section comprising an outer circumference, and wherein said non-smooth, textured outer surface is provided upon said entire outer circumference of said shank section.

4. The fish hook of claim 1, said shank section comprising an outer circumference, and wherein said non-smooth, textured outer surface is provided upon a portion of said outer circumference of said shank section.

5. The fish hook of claim 2, wherein said fishing fly dressings are selected from the group of feathers, fur, tinsel, artificial eyes, and artificial wings.

6. The fish hook of claim 1, wherein said fish hook is formed of a metal or metal alloy, and said non-smooth, textured outer surface of said shank portion has a texture selected from the group of a scored texture, a knurled texture, roughened texture resulting from sandblasting, roughened texture resulting from controlled corrosion, roughened texture resulting from controlled gouging or roughing via a machine, stamping, or casting.

7. The fish hook of claim 6, further including one or more fishing fly dressings secured to said non-smooth, textured outer surface of said shank section.

8. The fish hook of claim 7, said shank section comprising an outer circumference, and wherein said non-smooth, textured outer surface is provided upon said entire outer circumference of said shank section.

9. The fish hook of claim 1, wherein said non-smooth, textured outer surface of said shank portion comprises a textured material applied to said outer surface, said textured material selected from the group of paint, glaze, adhesives, rubber, and plastic.

10. The fish hook of claim 9, further including one or more fishing fly dressings secured to said non-smooth, textured outer surface of said shank section.

11. The fish hook of claim 10, said shank section comprising an outer circumference, and wherein said non-smooth, textured outer surface is provided upon said entire outer circumference of said shank section.

12. A fish hook comprising:
an elongated shank section and a U-shaped hook section;
said shank section having a looped end for attachment to a fishing line and an opposite end terminating into said U-shaped hook section;
said U-shaped hook section having a catch end, said catch end having a tip and a barb; and
a transverse bar secured to said shank section and oriented subjacent to said looped end, said bar configured for attaching one or more fishing fly dressings thereto.

13. The fish hook of claim 12, further including one or more fishing fly dressings secured to said transverse bar.

14. The fish hook of claim 13, wherein said fishing fly dressings are selected from the group of feathers, fur, tinsel, artificial eyes, and artificial wings.

15. The fish hook of claim 12, wherein said shank section further has a non-smooth, textured outer surface for securing one or more fishing fly dressings thereto.

16. The fish hook of claim 15, further including one or more fishing fly dressings secured to said non-smooth, textured outer surface of said shank section and one or more fishing fly dressings secured to said transverse bar.

17. The fish hook of claim 15, wherein said fishing fly dressings are selected from the group of feathers, fur, tinsel, artificial eyes, and artificial wings.

18. The fish hook of claim 15, wherein said fish hook is formed of a metal or metal alloy, and said non-smooth, textured outer surface of said shank portion has a texture selected from the group of a scored texture, a knurled texture, roughened texture resulting from sandblasting, roughened texture resulting from controlled corrosion, roughened texture resulting from controlled gouging or roughing via a machine, stamping, or casting.

19. The fish hook of claim 15, wherein said non-smooth, textured outer surface of said shank portion comprises a textured material applied to said outer surface, said textured material selected from the group of paint, glaze, adhesives, rubber, and plastic.
